(19) United States
(12) Patent Application Publication
(10) Pub. No.: US 2015/0261755 A1
(43) Pub. Date: Sep. 17, 2015

(54) PRIOR ART SEARCH APPLICATION USING INVENTION ELEMENTS

(71) Applicant: Dak Brandon Steiert, Edwards, CO (US)

(72) Inventor: Dak Brandon Steiert, Edwards, CO (US)

(21) Appl. No.: 14/210,349

(22) Filed: Mar. 13, 2014

(51) Int. Cl. G06F 17/30

(52) U.S. Cl. CPC G06F 17/3053; G06F 17/30386

(57) ABSTRACT

The software for searching prior art of the preferred embodiments includes an input interface, and allows a user to input one or more keywords related to at least two conceptual elements of an invention. The conceptual elements are preferably aspects of the ideas or innovations that make up the invention, where the conceptual elements together combine to describe at least the conceptual form of the invention. The conceptual elements, however, can represent any aspects of a conceptual or logical description or break down of the invention. The software for searching prior art of the preferred embodiments is designed to find a large fraction of the prior art related to an invention, and to sort the prior art so that the pieces of prior art most relevant to the invention are placed at the top of the search results. In an alternative use, the software for searching prior art of the preferred embodiments may be used to conduct research on a subject, including scientific or technical subjects. The software for searching prior art of the preferred embodiments may, however, be used for any suitable purpose.

### CROSS-REFERENCE TO RELATED APPLICATIONS

This application is a non-provisional continuation of U.S. Provisional Patent Application Ser. No. 61/802,411 filed 16 Mar. 2013 and entitled “PRIOR ART SEARCH APPLICATION USING INVENTION ELEMENTS”, the priority of which is claimed by this application, and the entire contents and substance of which are hereby incorporated in total by reference.

### BRIEF DESCRIPTION OF THE FIGURES

FIG. 1 is a schematic representation of the system of the first preferred embodiment.

FIG. 2 is a schematic representation of the system of the first preferred embodiment wherein the software counts the number of conceptual elements found in the pieces of prior art in the search results and sorts the search results taking into account the number of conceptual elements found in the pieces of prior art.

FIG. 3 is a schematic representation of the system of the first preferred embodiment wherein the results are sorted from the piece of prior art with the highest number of conceptual elements to the piece of prior art with the lowest number of conceptual elements.

FIG. 4 is a schematic representation of the system of the first preferred embodiment wherein the user can specify the industry the invention can be associated with.

FIG. 5 is a schematic representation of the system of the first preferred embodiment wherein the input includes a set of industry choices, wherein each industry choice is associated with a set of at least one keyword related to the industry choice, wherein the software takes into account the set of at least one keyword when sorting the search results.

FIG. 6 is a schematic representation of the system of the first preferred embodiment wherein the software conducts an initial search based on initial information input by the user, wherein the software logs at least one classification from at least one piece of prior art ranked highly in the sorted search results, wherein the software takes into account the at least one classification in a subsequent iterative search.

FIG. 7 is a schematic representation of the system of the first preferred embodiment wherein the software logs at least one classification found with high frequency among the highest ranked pieces of prior art in the sorted results and takes into account the at least one classification in a subsequent iterative search.

FIG. 8 is a schematic representation of the system of the first preferred embodiment wherein a user can specify the industry the invention can be associated with and the software takes into account the user specified industry when selecting at least one classification to log.

FIG. 9 is a schematic representation of the system of the first preferred embodiment wherein the software uses an algorithm to suggest either an additional search keyword or a keyword synonym, or both, wherein the algorithm takes into account the user specified industry either the initial information input by the user or at least one keyword related to each of at least two conceptual elements of the invention.

FIG. 10 is a schematic representation of the system of the first preferred embodiment wherein the software logs at least one piece of prior art referenced by at least one piece of prior art ranked highly in the sorted results.

FIG. 11 is a schematic representation of the system of the first preferred embodiment wherein the at least one referenced piece of prior art that was logged by the software is added to the search results, and the search results are sorted into an updated order by taking into account the number of conceptual elements found in the search results.

FIG. 12 is a schematic representation of the system of the first preferred embodiment wherein the software searches at least one prior art database using information including one or more of: a) at least one patent number, b) at least one application number, and c) at least one document title, where these pieces of information are associated with at least one piece of prior art ranked highly in the initial search results, wherein searching the at least one prior art database using this information returns any pieces of prior art with references to the at least one piece of prior art from the initial search results, wherein the pieces of prior art with references to the at least one piece of prior art from the initial results are added to the search results.

FIG. 13 is a schematic representation of the system of the first preferred embodiment wherein the user also inputs at least one search term, wherein the at least one search term is separate from the at least one keyword related to each of at least two conceptual elements of an invention.

FIG. 14 is a schematic representation of the system of the first preferred embodiment wherein the result sorting takes into account the number of keywords or keyword sets related by OR boolean operators.

FIG. 15 is a schematic representation of the system of the first preferred embodiment wherein the user is prompted to enter broader and narrower versions of a search term.

FIG. 16 is a schematic representation of the system of the first preferred embodiment wherein the search terms search in the abstracts instead of the titles if a low number of results are returned.

FIG. 17 is a schematic representation of the system of the first preferred embodiment wherein the user selects one or more conceptual elements, and pieces of prior art containing those specific elements are returned for viewing.

FIG. 18 is a schematic representation of the system of the first preferred embodiment wherein searching is related to a research topic composed of conceptual elements.

FIG. 19 is a schematic representation of the system of the first preferred embodiment wherein documents referenced by highly ranked pieces of prior art are searched and ranked, and the results of these searches are iteratively followed until highly ranked documents are no longer returned.

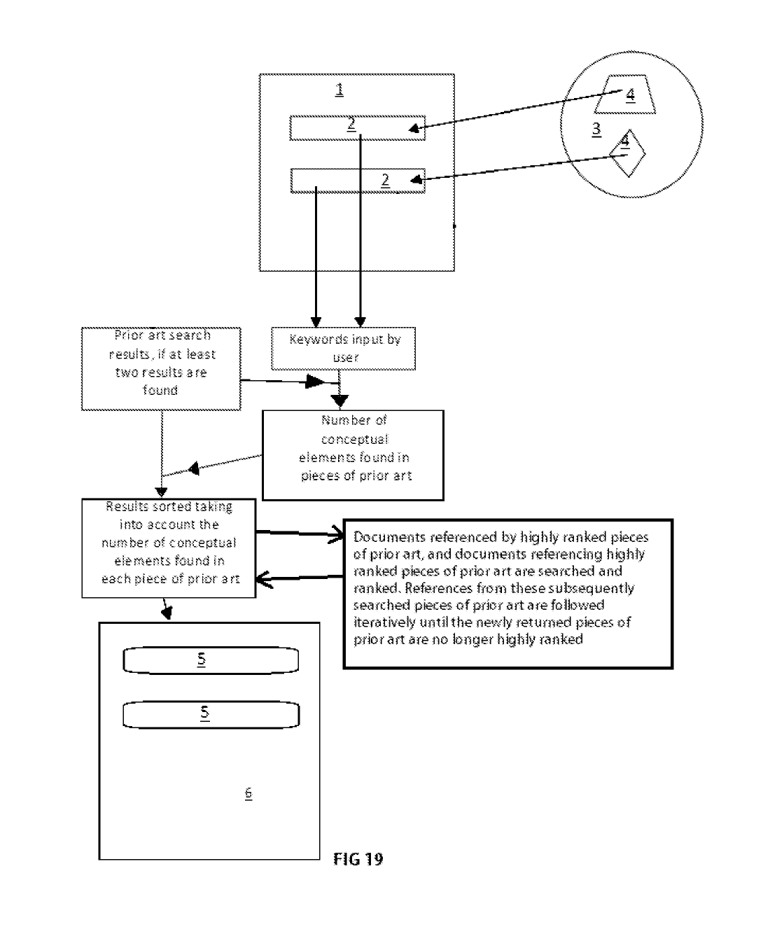

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

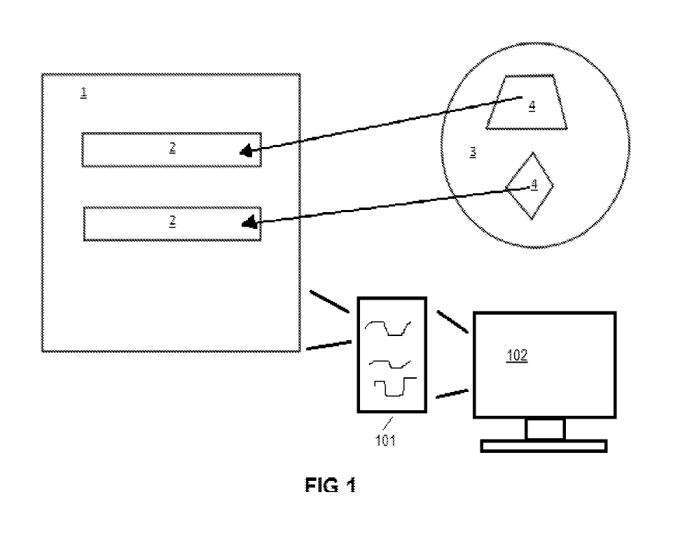

As shown in FIG. 1, the software for searching prior art of the preferred embodiments includes an input interface 1, and allows a user to input one or more keywords related to at least two conceptual elements 4 of an invention 3. The software comprises an algorithm 101 stored on computer-readable medium 102. Preferably the user inputs these keywords using text input boxes 2, but any suitable input means may be used. The conceptual elements 4 are preferably aspects of the ideas or innovations that make up the invention 3, where the conceptual elements 4 together combine to describe at least the conceptual form of the invention 3. The conceptual elements 4, however, can represent any aspects of a conceptual or logical description or break down of the invention 3. The software for searching prior art of the preferred embodiments is designed to find a large fraction of the prior art related to an invention 3, and to sort the prior art so that the pieces of prior art most relevant to the invention 3 are placed at the top of the search results 6. In an alternative use, the software for searching prior art of the preferred embodiments may be used to conduct research on a subject, including scientific or technical subjects. The software for searching prior art of the preferred embodiments may, however, be used for any suitable purpose.

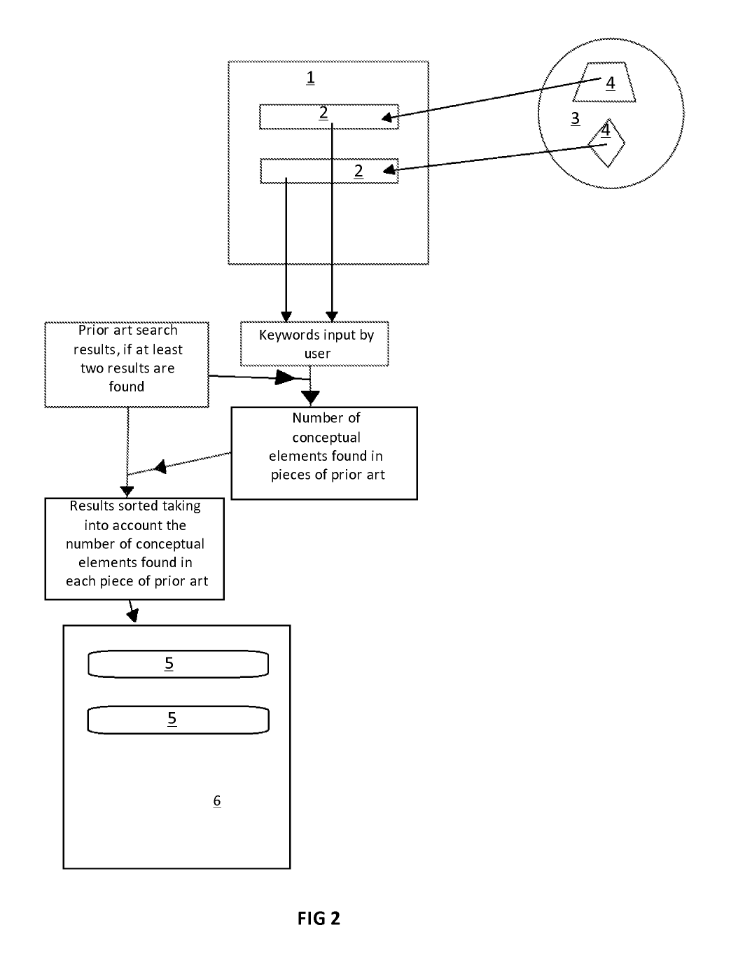

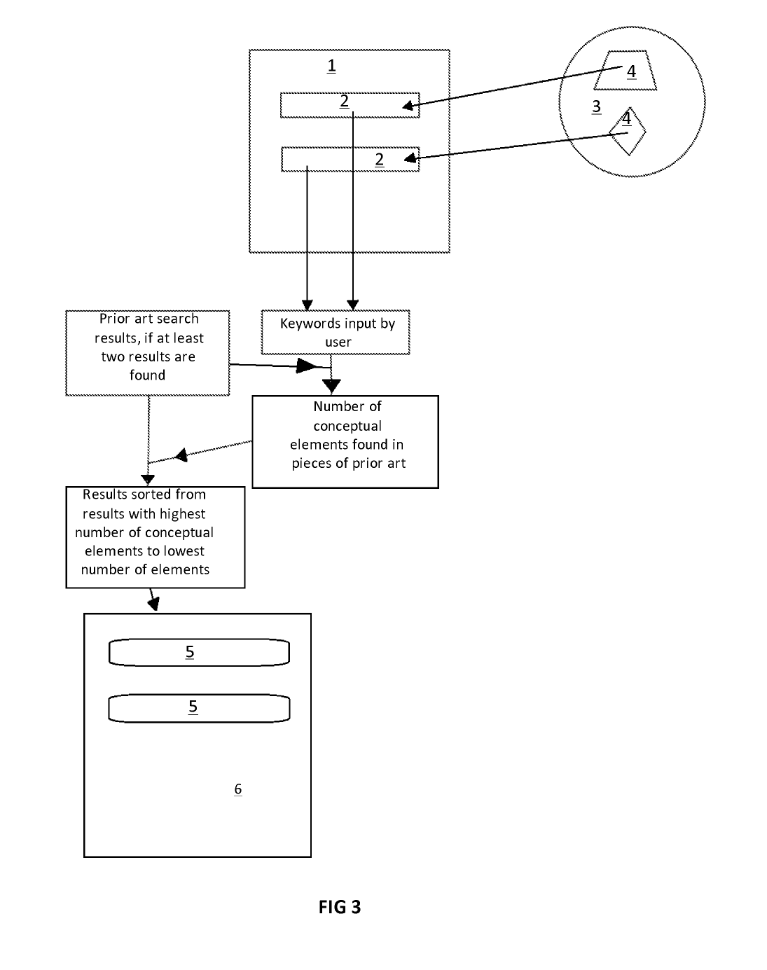

As shown in FIG. 2, the software for searching prior art preferably sorts search results 6 using information including the number of conceptual elements 4 input by the user that were found in the pieces of prior art. The criteria for finding a conceptual element in a piece of prior art preferably involves finding one or more keywords entered by the user in association with the conceptual element in the piece of prior art. In an alternate variation, the criteria for finding a conceptual element in a piece of prior art may involve finding one or more keywords entered by the user in association with the conceptual element with a frequency or number of occurrences greater than a pre-defined limit in the piece of prior art. The criteria for finding a conceptual element in a piece of prior art may, however, involve any suitable means. As shown in FIG. 3, in one variation, the search results 6 are sorted in order from the piece of prior art with the most number of conceptual elements 4 to the piece of prior art with the least number of conceptual elements 4. In a second variation, the number of conceptual elements 4 found in the pieces of prior art is given a weighted score and used along with other criteria to sort the search results 6. The other criteria used to sort the search results 6 can include: the frequency or number of occurrences of keywords input by the user in association with a conceptual element in a piece of prior art; the classifications found in a piece of prior art; the references to other pieces of prior art found in a piece of prior art; the assignees of a piece of prior art; the industry a piece of prior art can be associated with; the presence of other user input information in a piece of prior art; the relevance of the drawings in a piece of prior art to the information input by the user. Any suitable method may, however, be used to sort the search results 6.

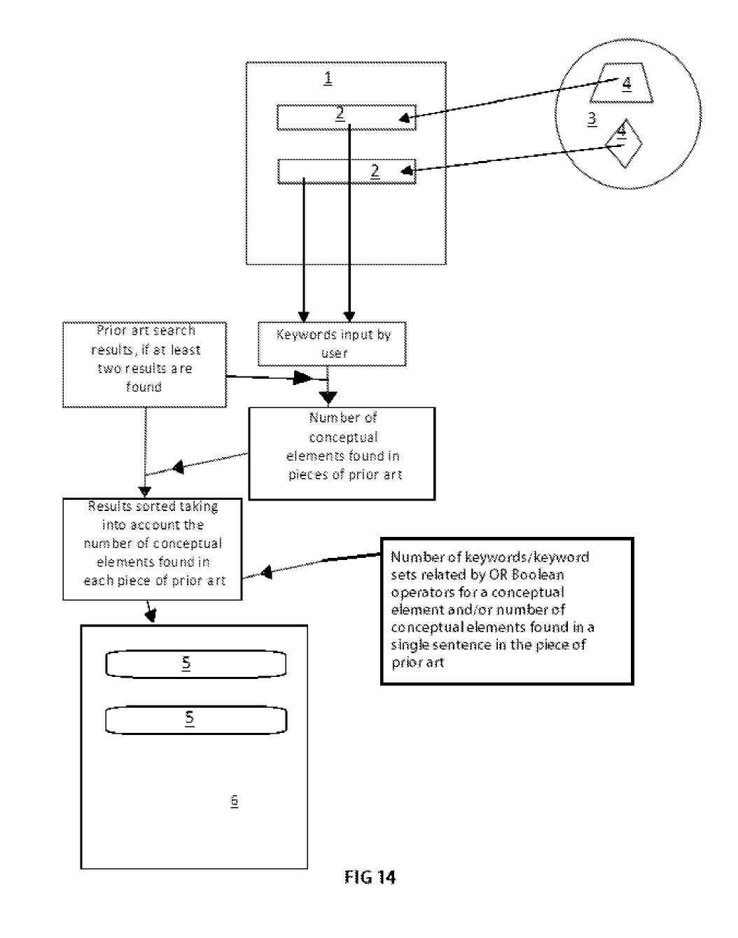

As shown in FIG. 14, the keywords representing the conceptual elements 4 may contain include multiple keywords, and some of the keywords may be related to one another with Boolean OR operators. The Boolean OR operators signify that different keywords or sets of keywords may be used to represent a given conceptual element 4. The software for searching prior art preferably also sorts results 6 by taking into account the number of terms separated by OR operators found in a piece of prior art. If a given conceptual element 4 is entered by the user as “A OR B OR C” where A, B and C are one or more keywords or phrases that can represent the given conceptual element 4, the software for searching prior art preferably ranks pieces of prior art containing all three of A, B, C above pieces of prior art containing only one or two of A, B, and C. The pieces of prior art containing a given number of conceptual elements 4 are preferably ranked within themselves by an algorithm including the number of keywords or sets of keywords separated by Boolean OR's for each conceptual element 4 found in the piece of prior art. The software for searching prior art preferably also determines if there are one or more sentences in the piece of prior art with more than one conceptual elements 4 contained in a single sentence. Preferably the single sentence containing the most number of conceptual elements 4 in the piece of prior art is selected, and the software for searching prior art preferably ranks pieces of prior art from the results 6 with a higher number of conceptual elements in a single sentence higher than pieces of prior art with fewer conceptual elements in a single sentence. Preferably the software for searching prior art sorts the pieces of prior art in the results 6 with a given number of conceptual elements 4 within themselves using an algorithm that factors inthe number of conceptual elements 4 found in the selected single sentence, and the number of keywords or sets of keywords separated by OR operators for each conceptual element 4 found in the piece of prior art. As an example, if nine conceptual elements 4 are entered, there may be more than one pieces of prior art in the results 6 that contain four of the conceptual elements 4. These pieces of prior art each containing four of the conceptual elements 4 can be sorted within the group of pieces of prior art containing four conceptual elements 4 by factoring in both the number of conceptual elements 4 found in the selected single sentence and the number of keywords or sets of keywords separated by OR operators for each conceptual element that are found in each piece of prior art. In another preferred variation, the number of sentences in the piece of prior art containing more than one conceptual element 4 can also be factored into the sorting algorithm. In another preferred variation, the number of conceptual elements 4 found in a single sentence in a piece of prior art may be factored into a sorting algorithm along with the number of conceptual elements 4 found in the piece of prior art to sort the pieces of prior art in the results 6. In this variation, a piece of prior art with fewer conceptual elements 4 may be rated above a piece of prior art containing more conceptual elements 4 if the piece of prior art with fewer conceptual elements 4 contains more conceptual elements 4 in one sentence. Preferably the number of sentences containing more than one conceptual element 4 would be normalized by the total number of sentences in the piece of prior art. The pieces of prior art in the results 6 containing a given number of conceptual elements 4 may, however, be sorted by any suitable means or may not be sorted at all. The pieces of prior art in the results 6 may also be sorted by an algorithm that factors in the number of conceptual elements 4 found in the pieces of prior art, and one or more of: the number of conceptual elements 4 found in a single sentence, the number of sentences with more than one conceptual element 4 in the piece of prior art normalized by the number of sentences in the piece of prior art, and the number of keywords or sets of keywords related by OR operators defining the conceptual elements 4 found in the piece of prior art. The pieces of prior art may, however, be sorted only factoring in the number of conceptual elements 4 found in the pieces of prior art, or factoring in any other suitable information as well while sorting the number of conceptual elements 4 found in the pieces of prior art.

In a preferred variation of the software for searching prior art, the software returns one or more of the sentences containing more than one conceptual elements 4 to the user along with the rest of the information returned to the user at the end of the search.

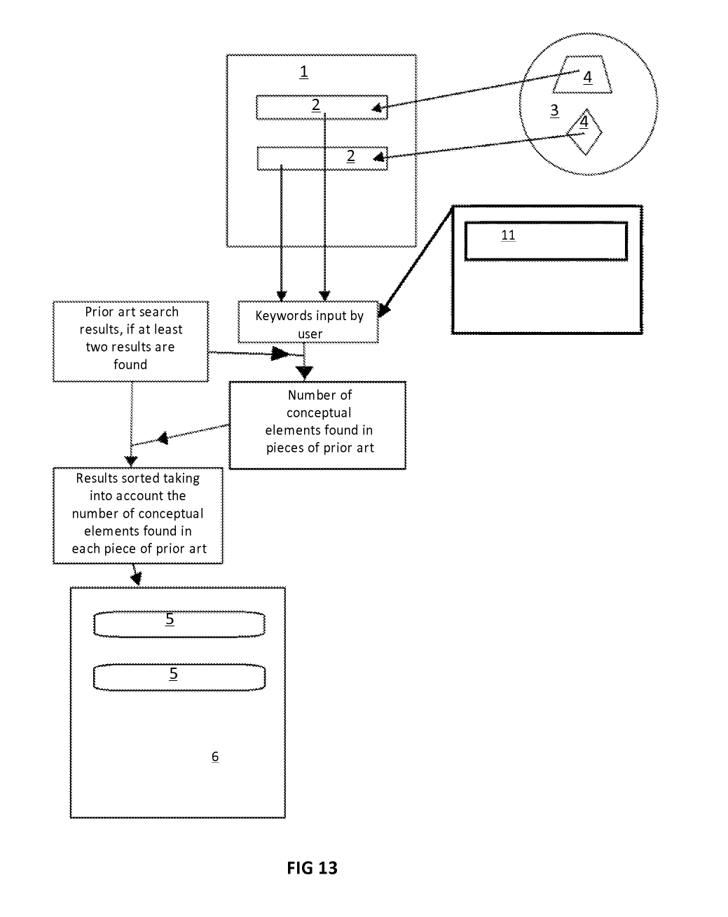

As shown in FIG. 13, the software for searching prior art preferably also includes an input for one or more search terms 11 that are input separately from the conceptual elements 4. The one or more search terms 11 can be the same as, similar to, or totally distinct from the keywords the user inputs in association with the conceptual elements 4 of the invention 3. However, any suitable additional input may be taken from the user, or no additional input at all.

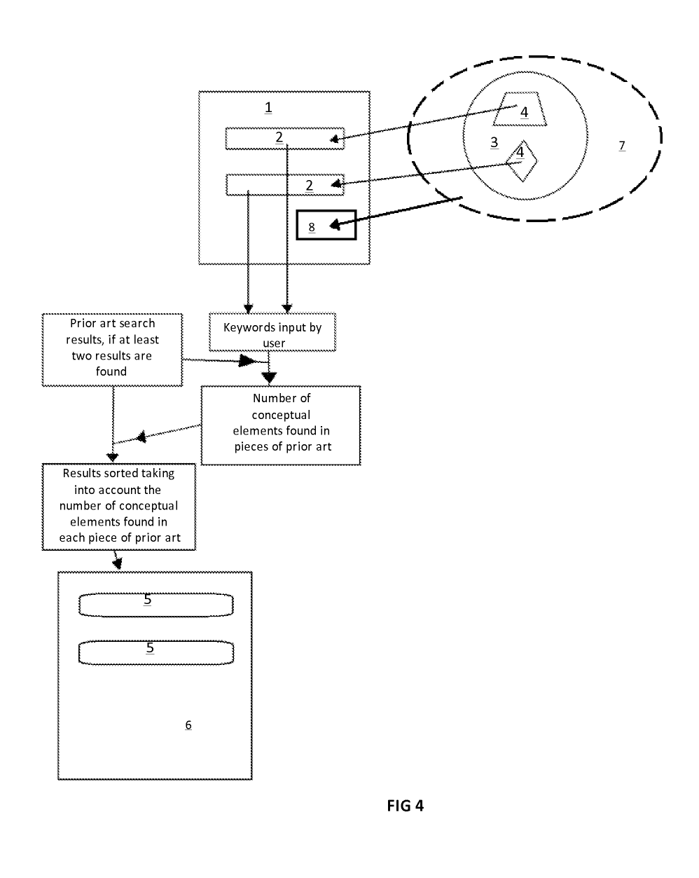

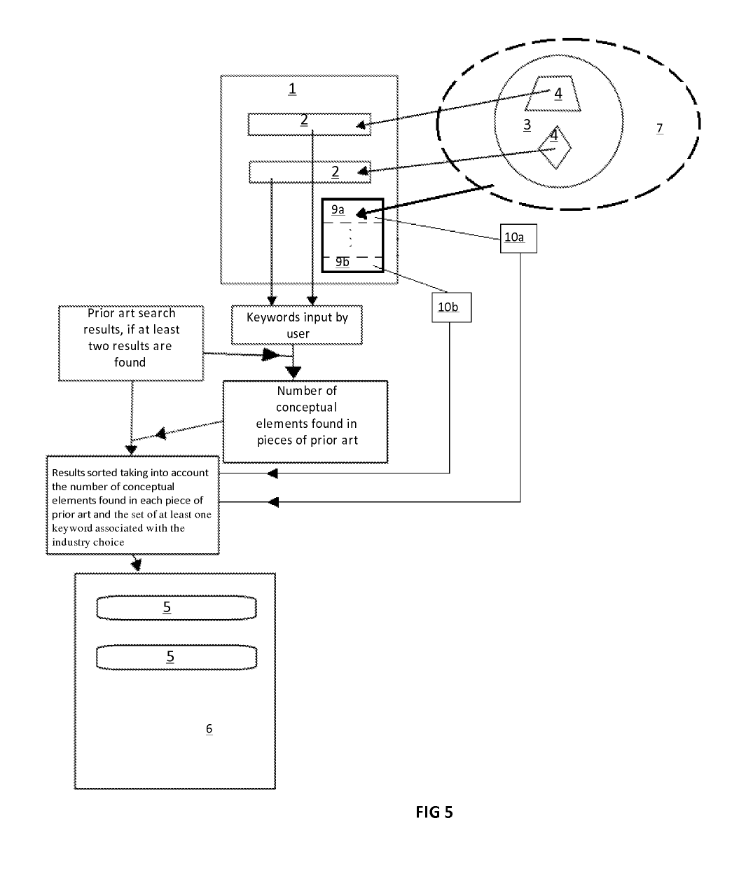

As shown in FIG. 4, in a variation of the software for searching prior art of the preferred embodiments, the software includes an input to allow the user to specify the industry the invention can be associated with 7. Examples of industries include electronics, construction, real estate, and biochemistry. However, these are just a small number of examples and the industry the invention can be associated with 7 can be any suitable industry. As shown in FIG. 5, in a variation, the user is given a set of industry choices 9a, 9b to select from. Preferably the industry choices 9a, 9b are associated with one or more keywords. The industry choices 9a, 9b may, however, be associated with any suitable information useful for identifying the relation of a document to the industry choices 9a, 9b. The user may, however, specify the industry the invention can be associated with 7 by any suitable means. In a variation, the search results 6 are sorted with a weighted formula using the industry the invention can be associated with 7 that the user input, the number of conceptual elements 4 found in the pieces of prior art, and any other suitable information. Preferably, the software marks the pieces of prior art as being in the industry specified by the user 8, or not in the industry specified by the user 8. Preferably, the software determines if a piece of prior art is in the industry specified by the user 8 by checking if a piece of prior art meets one or more of these criteria: at least a specified number of keywords associated with the industry choice 10a, 10b selected by the user are found in the piece of prior art, or one or more keywords associated with the industry choice 10a, 10b selected by the user are found either a number of times or with a frequency equal to or greater than a preselected level. In a variation, the software determines if a piece of prior art is in the industry specified by the user 8 by checking to see if any of the keywords associated with the industry choice 10a, 10b selected by the user are found in the piece of prior art. The software may, however, determine if a piece of prior art is in the industry specified by the user 8 with any suitable means. The software may, however, use the industry specified by the user 8 in any suitable way.

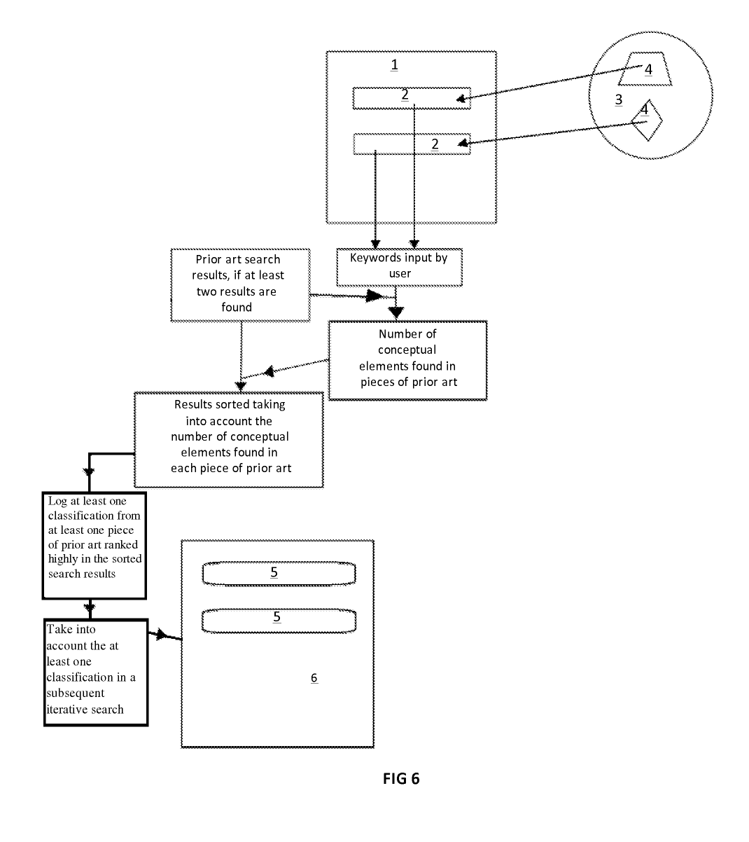

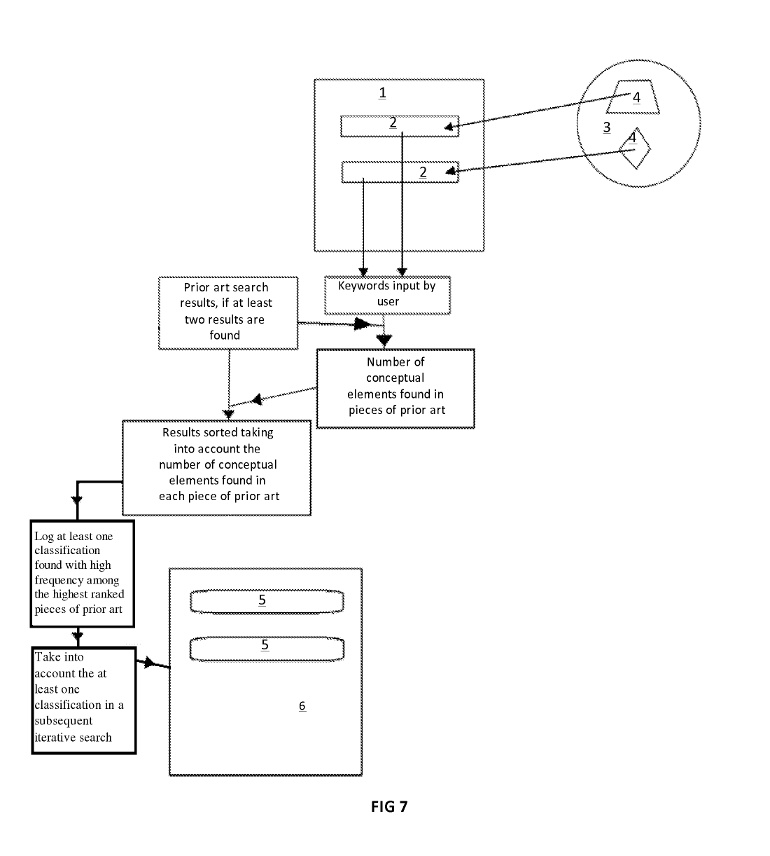

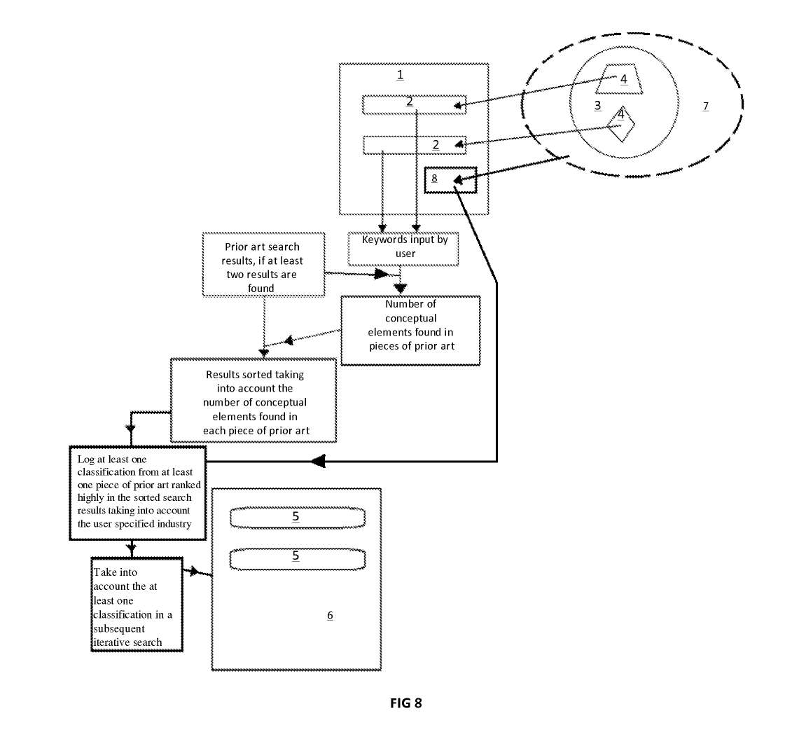

As shown in FIG. 6, in a preferred variation of the software for searching prior art of the preferred embodiments, the software conducts an initial search based on initial information input by the user. The initial information input by the user preferably comprises one or both of: the keywords associated with the conceptual elements 4 of the invention 3 input by the user, and one or more search terms 11 input separately from the keywords associated with the conceptual elements 4. The software preferably logs one or more classifications from at least one piece of prior art ranked highly in the initial search results 6. The classifications are preferably patent classifications, but the classifications can be any suitable information structured across multiple documents. The one or more classifications are preferably logged from the pieces of prior art ranked highest in the search results 6, but they can be logged from any suitable pieces of prior art. As shown in FIG. 7, preferably classifications found with high frequency among the highest ranked pieces of prior art are logged. As shown in FIG. 8, in one preferred variation, the industry associated with the invention 7 specified by the user is also taken into account when selecting which classifications from the pieces of prior art in the search results 6 to log. However, classifications from the pieces of prior art in the search results 6 may be logged using any suitable criteria. Preferably the software conducts a subsequent iterative search taking into account the one or more classifications logged. In one preferred variation, the software conducts an iterative search using the initial information input by the user and the one or more classifications logged. In another preferred variation, the software conducts an iterative search using a broader version of the initial information input by the user and the one or more classifications logged, along with any other suitable information. The broader version of the initial information input by the user is preferably determined by an algorithm that modifies the initial information input by the user.

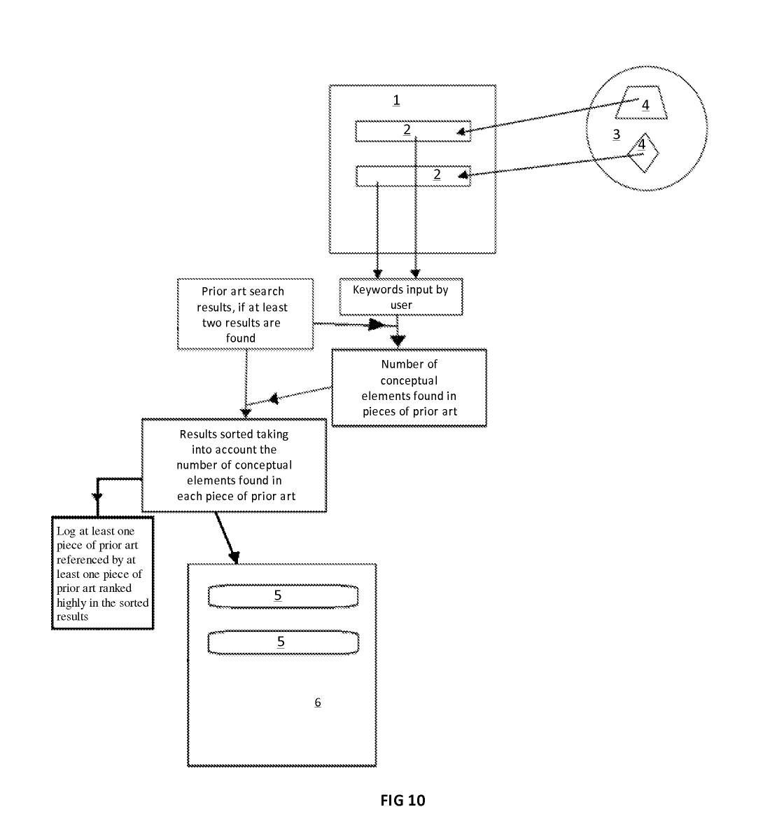

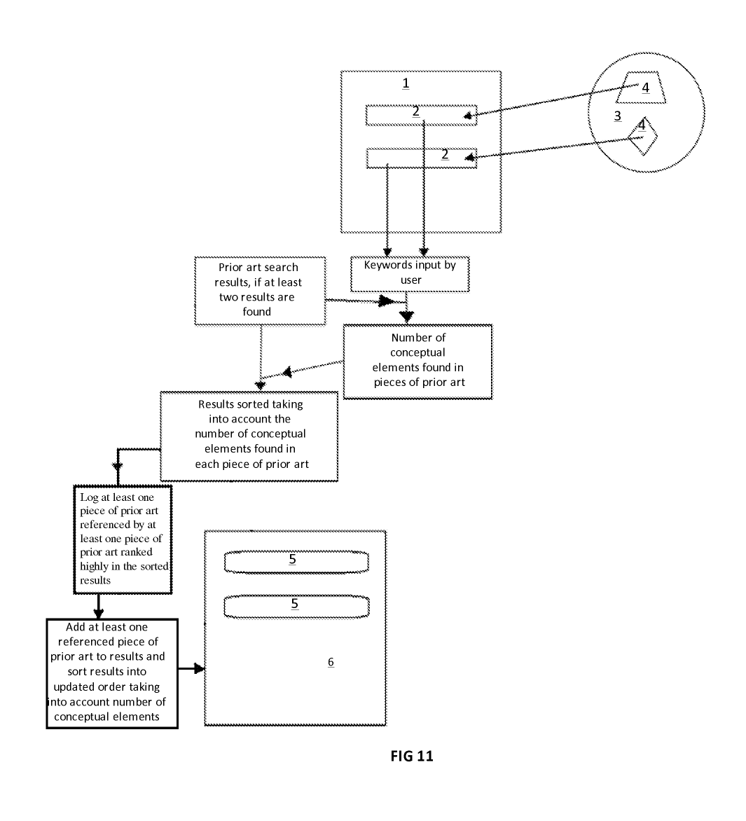

As shown in FIG. 10, in another preferred variation of the software for searching prior art of the preferred embodiments, the software logs one or more pieces of prior art referenced in at least one piece of prior art ranked highly in the initial search results 6. As shown in FIG. 11, preferably the one or more referenced pieces of prior art are added to the search results 6. Preferably the updated search results are sorted into an updated order, preferably by using the number of conceptual elements 4 found in each piece of prior art. The updated search results may, however, be sorted into an updated order using any suitable means, or may not be sorted into an updated order. The updated search results may be used in any suitable manner. Preferably the software logs all pieces of prior art referenced in the pieces of prior art ranked above a pre-defined level in the search results 6. The software may, however, log any suitable number of referenced pieces of prior art from any of the suitable pieces of prior art from the initial search results 6.

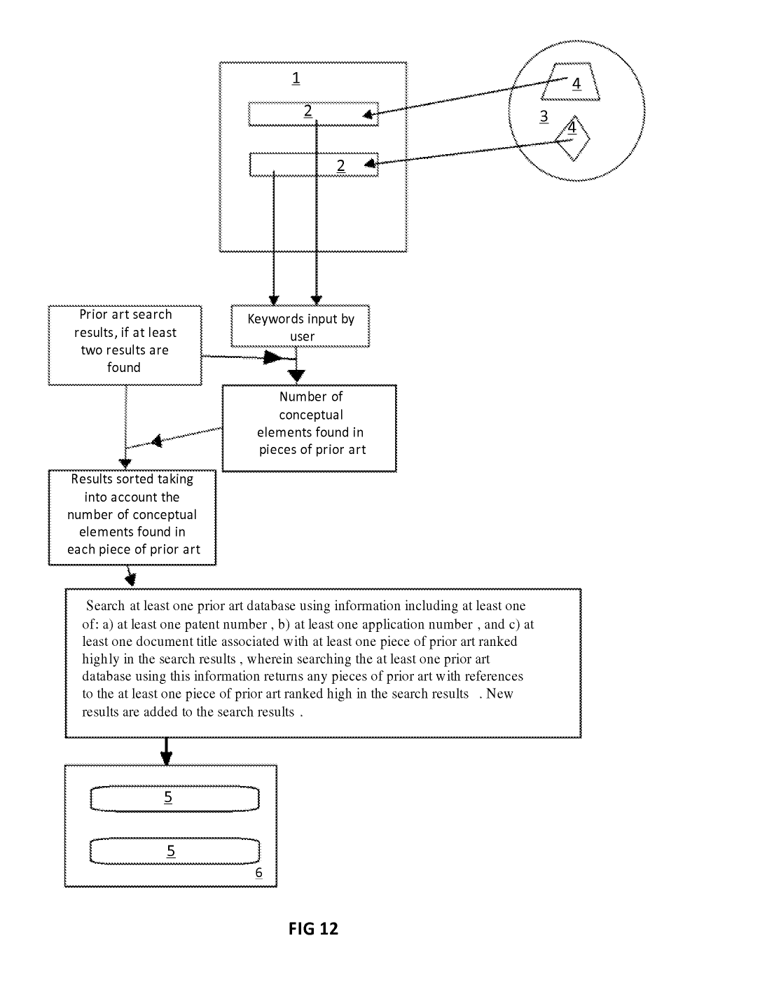

As shown in FIG. 12, in another preferred variation of the software for searching prior art of the preferred embodiments, the software conducts a subsequent search of at least one prior art database using information related to at least one piece of prior art ranked highly in the initial search, where the information includes one or more of: one or more patent number, one or more application number, and one or more document title associated. Searching the prior art database using this information returns any pieces of prior art with references to the the at least one piece of prior art ranked highly in the initial search, and these pieces of prior art are preferably added to the search results 6. Preferably the updated search results are sorted into an updated order, preferably by using the number of conceptual elements 4 found in each piece of prior art. The updated search results may, however, be sorted into an updated order using any suitable means, or may not be sorted into an updated order. The updated search results may be used in any suitable manner. Preferably the software conducts a subsequent search using information related to all of the pieces of prior art ranked above a pre-defined level in the search results 6. Preferably this is done using patent or application numbers, but it may be done with any suitable information related to the pieces of prior art in the search results 6. The software may, however, conduct a subsequent search with information related to any suitable pieces of prior art from the initial search results 6.

As shown in FIG. 20, in a preferred variation the software for searching pieces of prior art may conduct subsequent searches for pieces of prior art referenced by the pieces of prior art returned in the initial search, or in previous iterations of the search. Preferably the software also searches pieces of prior art referencing the pieces of prior art returned in the initial search, or in previous iterations of the search. In this preferred variation, the software preferably searches documents referencing and referenced by the pieces of prior art returned in the initial search or in previous iterations of the search that were ranked highly in the sorting algorithms. In this preferred variation of the invention, the software continues to conduct subsequent searches for pieces of prior art referencing and referenced by highly ranked pieces of prior art until the pieces of prior art returned by the subsequent searching among referenced and referencing patents no longer returns highly ranked pieces of prior art. In one variation, the definition for no longer returning highly ranked pieces of prior art is when not one of the referenced and referencing pieces of prior art contains as many or more conceptual elements 4 as the current highest ranked piece or pieces of prior art. In another variation, the definition for no longer returning highly ranked pieces of prior art is when not one of the referenced and referencing pieces of prior art contains at least one fewer conceptual elements 4 than the current highest ranked piece or pieces of prior art. The definition of no longer returning highly ranked pieces of prior art can be any suitable definition. Preferably, the subsequent searching is stopped when highly ranked pieces of prior art are no longer returned relative only to a single piece of highly ranked prior art, and references related to other highly ranked pieces of prior art are followed until they stop returning highly ranked pieces of prior art. References and referenced pieces of prior art may, however, be searched in any suitable manner and with any suitable pieces of prior art.

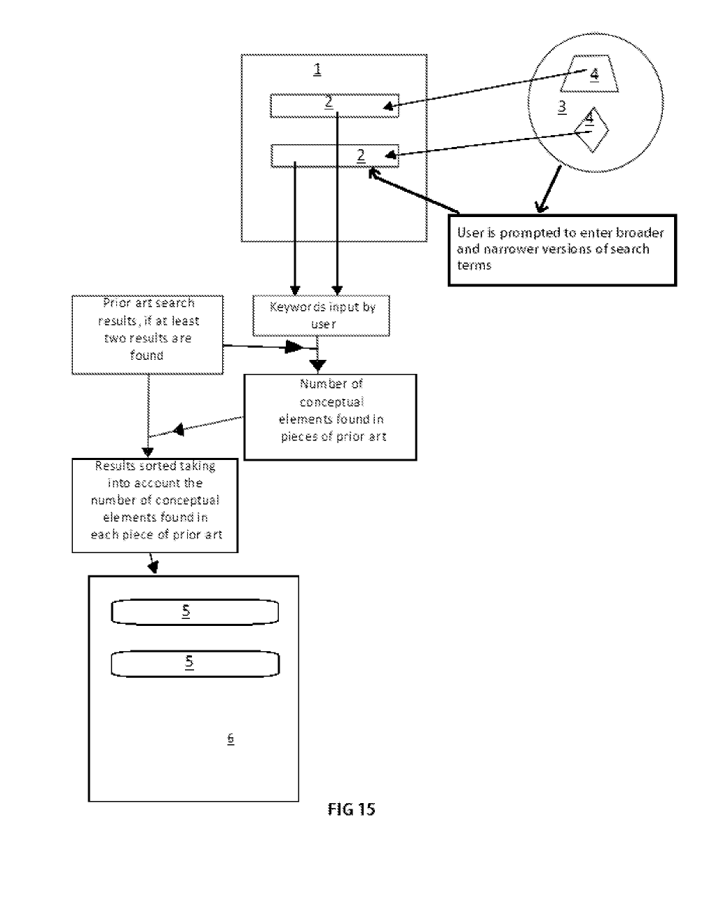

As shown in FIG. 15, in an alternative variation of the software for searching prior art, the software prompts the user to enter both a broader version of the search terms 11 and a narrower version of the search terms 11, where the broader version is less specific and is likely to return a larger number of results 6 than the narrower version. The broader version of the search terms 11 is used in one variation to conduct subsequent searches in classifications found to be relevant to the invention 3, references from pieces of prior art ranked highly in the sorted search results 6, and pieces of prior art containing references to inventors or companies supplied by the user 6. The software returns pieces of prior art searched in these contexts as long as they match the broader version of the search terms 11. In another variation, the software changes one or more AND Boolean operators contained in the search terms 11, if any are contained in the search terms 11, to OR Boolean operators to automatically create a broader version of the search terms 11 for subsequent searching in classifications found to be relevant to the invention 3, references from pieces of prior art ranked highly in the sorted search results 6, and pieces of prior art containing references to inventors or companies supplied by the user 6.

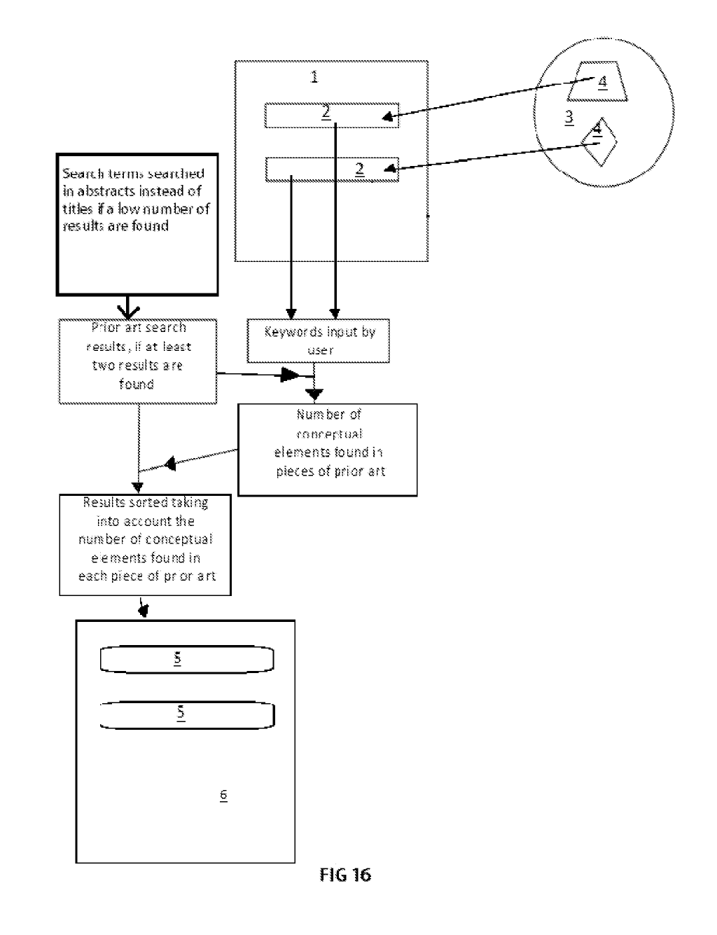

As shown in FIG. 16, when the software for searching prior art returns initial search results, if a low number of initial results are returned, the software conducts a subsequent search where any search terms 11 that were matched against the titles of pieces of prior art are matched against the abstracts of pieces of prior art. Generally this will return a larger number of pieces of prior art in the results 6. A low number of initial results can be pre-defined by constant or by formula or algorithm. Examples of a low number of initial results may be 0, less than 20, less than 100, or less than 500. However, any suitable number, formula or algorithm may be used to determine what number of pieces of prior art is a low number and triggers the subsequent search in the abstracts instead of the titles. The software may, however, use any suitable method to obtain more pieces of prior art, or may not make any adjustments at all to find more pieces of prior art.

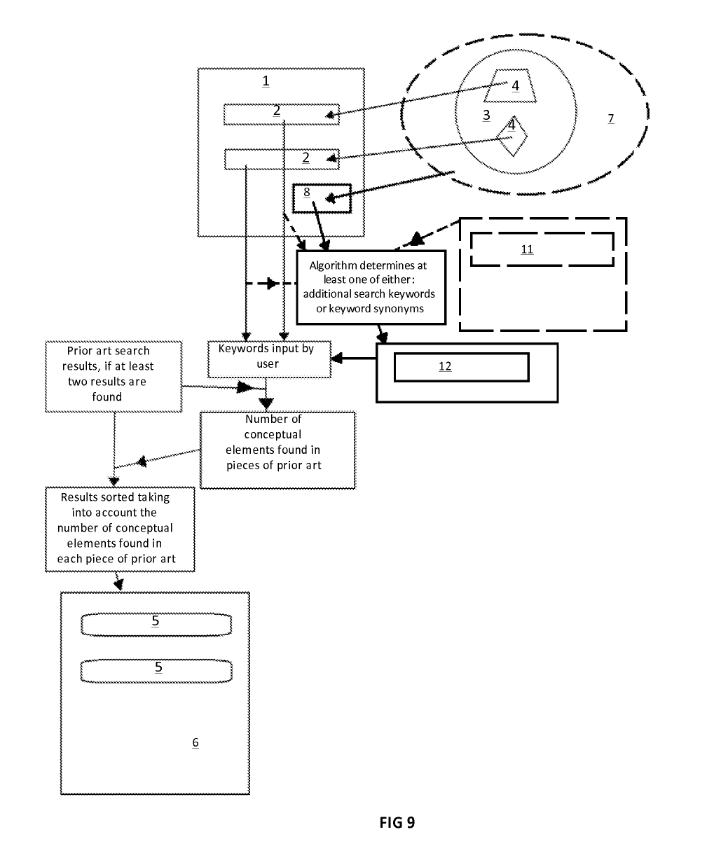

As shown in FIG. 9, in another preferred variation of the software for searching prior art, the software uses an algorithm to suggest either an additional search keyword 12 or a keyword synonym 12, or both. The algorithm selects the one or more words to suggest using the industry specified by the user 8 and either the initial information input by the user, or the one or more keywords input by the user in association with the conceptual elements 4 of the invention 3. In one preferred variation, the software searches one or more of the initial keywords input by the user in a thesaurus and selects at least one additional word from the thesaurus results using the industry specified by the user 8. In a preferred variation this is done by selecting any group of words returned by the thesaurus search that also contains at least one keyword associated with the industry choice 10a, 10b selected by the user. In another preferred variation, the selection of keyword synonyms 12 to suggest to the user is done by searching the words returned by the thesaurus search in a dictionary, and selecting any of the words returned by the thesaurus search that have at least one keyword associated with the industry choice 10a, 10b selected by the user in the associated dictionary entry. In another preferred variation, the selection of keyword synonyms 12 to suggest to the user is done by searching the words returned by the thesaurus search in a dictionary, and searches the initial keyword input by the user 8 in a dictionary, and then selecting any of the words returned by the thesaurus search that has a dictionary definition with one or more words in common with the dictionary definition of the initial keyword input by the user 8. Preferably a pre-defined fraction of the number of the words in the two definitions must match for the word returned by the thesaurus to be selected as a keyword synonym 12. In another variation, at least a certain number of keywords associated with the industry choice 10a, 10b must be found in either the group of words returned by the thesaurus search, or in the associated dictionary entry in order to select words from the thesaurus search. In a second preferred variation, the software searches a database with information summarizing subjects related to the invention 3, preferably an encyclopedia or an internet search engine. Preferably the software analyzes the words used in the results returned by searching the database with information summarizing subjects related to the invention 3. Preferably the software ignores the words that appear most frequently in the language the results are written in, words such as “the” or “of” in the English language. Preferably the software searches the remaining words in a dictionary and selects any of the words that have at least one keyword associated with the industry choice 10a, 10b selected by the user in the associated dictionary entry. In a preferred variation, the software selects the remaining words that occur more than a specified number of times or with greater than a specified frequency in the results returned by the search in the database with information summarizing subjects related to the invention 3. In another variation the software searches in a dictionary for the remaining words that occur more than a specified number of times or with greater than a specified frequency in the results returned by the search in the database with information summarizing subjects related to the invention 3, and selects any of the words that have at least one keyword associated with the industry choice 10a, 10b selected by the user in the associated dictionary entry. In another preferred variation, the selection of keyword synonyms 12 to suggest to the user is done by searching the words that are found by the search in the database with information summarizing subjects related to the invention 3 in a dictionary, and searches the initial keyword input by the user 8 in a dictionary, and then selecting any of the words that are found by the search in the database with information summarizing subjects related to the invention 3 that has a dictionary definition with one or more words in common with the dictionary definition of the initial keyword input by the user 8. Preferably a pre-defined fraction of the number of the words in the two definitions must match for the word returned by the thesaurus to be selected as a keyword synonym 12. The software may, however, use any suitable method to suggest either an additional search keyword 12 or a keyword synonym 12, or both.

In a preferred variation, the software selects one or more pieces of prior art containing each of the conceptual elements 4. Preferably this is done by creating a set of the pieces of prior art that contain each of the conceptual elements 4, then ordering each of these sets from the pieces of prior art containing the most total pieces of prior art to the least pieces of prior art. Preferably the software selects at least one piece of prior art ranked highest in each of these sets. The selection may, however, involve any other suitable criteria as well. The selected pieces of prior art are preferably returned to the user as a summary of the pieces of prior art that are most relevant to each of the conceptual elements 4 of the invention 3.

In a preferred variation, the software selects quotes from the pieces of prior art related to each of the conceptual elements 4 found in the individual pieces of prior art and adds the quotes to the search results 6 with the text from the pieces of prior art. Preferably this is done by selecting sentences or segments of text containing at least one keyword input by the user in association with each conceptual element.

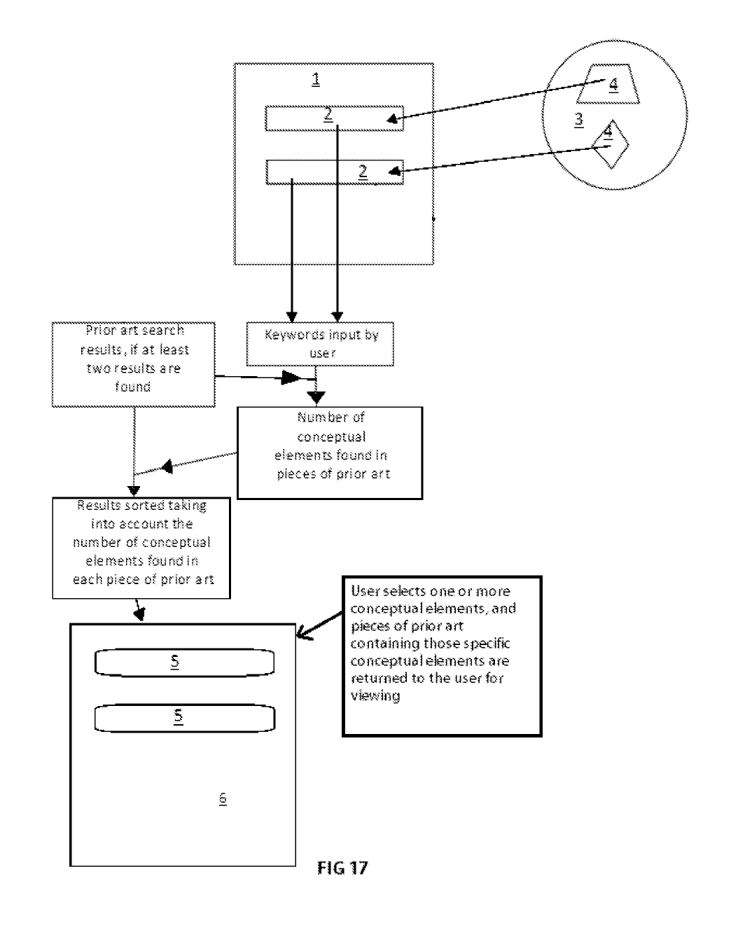

As shown in FIG. 17, in a preferred variation of the software for searching prior art the user 8 may select one or more of the conceptual elements 4 and see a report showing only pieces of prior art containing the conceptual elements 4 selected by the user 8. The user 8 can change the selection to see pieces of prior art related to different aspects or combinations of conceptual elements 4 of the invention 3. The software may, however, output any suitable report of the pieces of prior art found through searching.

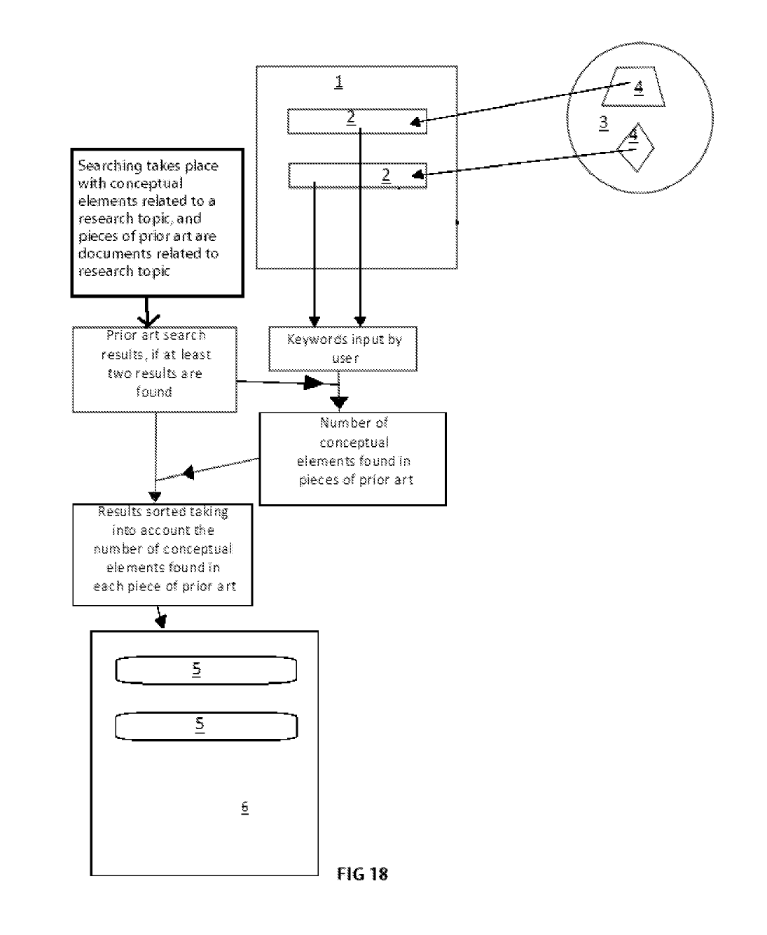

As shown in FIG. 18, the software for searching prior art may be used to conduct research. This research may include scientific research, and may involve searching patents, scientific journals, and other documents. Instead of searching for conceptual elements 4 related to an invention 3, the conceptual elements 4 input by the user 8 would relate to a topic of research. The pieces of prior art returned in this variation would be documents related to the topic of research. The software may, however, be used for any suitable purpose.

Preferably, several of these variations are implemented together in one embodiment of the software that uses several methods to improve search results 6 and rankings. However, only one of the variations may be implemented, or the variations may be implemented separately or in any suitable combination. In a variation the iterative searches described above may be carried out in more than one iteration, however any suitable number of iterations may be used.

As a person skilled in the prior art will recognize after examination of the previous detailed description and the figures and claims, modifications and changes may be made to the preferred embodiments of the invention without departing from the scope of the invention as defined in the following claims.

I claim:

1. Software for searching patent prior art comprising computer-readable medium, and an algorithm stored on the computer readable medium further comprising: an input interface, wherein the input interface allows a user to input at least one keyword related to each of at least two conceptual elements of an invention.

2. The software of claim 1 further comprising a sorting algorithm adapted to sort search results by taking into account the number of conceptual elements found in at least one piece of prior art, wherein the criteria for finding a conceptual element in a piece of prior art comprises finding at least one keyword entered by a user in relation to that conceptual element.

3. The software of claim 2 wherein the search results are sorted from the piece of prior art that has the highest number of conceptual elements found in that piece of prior art to the piece of prior art that has the least number of conceptual elements found in that piece of prior art.

4. The software of claim 2, further comprising an input adapted to allow a user to specify the industry the invention can be associated with.

5. The software of claim 4, wherein the input further comprises a set of industry choices, wherein each industry choice is associated with a set of at least one keyword related to the industry choice.

6. The software of claim 5, wherein the software takes into account the set of at least one keyword when sorting the search results.

7. The software of claim 2, wherein the software conducts an initial search based on initial information input by the user, wherein the software is adapted to log at least one classification from at least one piece of prior art ranked highly in the sorted search results, wherein the software is adapted to take into account the at least one classification in a subsequent iterative search.

8. The software of claim 7, wherein the software logs at least one classification found with high frequency among the highest ranked pieces of prior art in the sorted results.

9. The software of claim 7, further comprising an input adapted to allow a user to specify the industry the invention can be associated with, wherein the software takes into account the user specified industry when selecting at least one classification to log.

10. The software of claim 4, wherein the software comprises an algorithm that suggests at least one of 1) an additional search keyword and 2) a keyword synonym, wherein the algorithm takes into account the user specified industry and at least one of a) the initial information input by the user and b) the at least one keyword related to each of at least two conceptual elements of the invention.

11. The software of claim 2, wherein the software logs at least one piece of prior art referenced by at least one piece of prior art ranked highly in the sorted results.

12. The software of claim 11, wherein the at least one referenced piece of prior art that was logged by the software is added to the search results, wherein the search results are sorted into an updated order by taking into account the number of conceptual elements found in the search results.

13. The software of claim 2, wherein the software searches at least one prior art database using information comprising at least one of: a) at least one patent number, b) at least one application number, and c) at least one document title associated with at least one piece of prior art ranked high in the search results, wherein searching the at least one prior art database with this information returns any pieces of prior art with references to the at least one piece of prior art ranked high in the search results, wherein the pieces of prior art with references to the at least one piece of prior art ranked high in the search results are added to the search results.

14. The software of claim 13, wherein if any results are returned with references to the at least one piece of prior art ranked high in the search results the search results are sorted into an updated order by taking into account the number of conceptual elements found in the search results.

15. The software of claim 2, wherein the user also inputs at least one search term, wherein the at least one search term is entered separately from the at least one keyword related to each of at least two conceptual elements of an invention.

16. The software of claim 1, further comprising a sorting algorithm adapted to select at least one piece of prior art containing each conceptual element, wherein the at least one piece of prior art containing each conceptual element is selected by choosing at least one piece of prior art that contains each individual conceptual element and also contains the greatest number of other conceptual elements.
